(19) United States
(12) Patent Application Publication
(10) Pub. No.: US 2008/0013856 A1
(43) Pub. Date: Jan. 17, 2008

(54) METHOD FOR OBTAINING HIGH SNR IMAGE

(75) Inventor: Wei Hsu, Taipei (TW)

Correspondence Address: KIRTON AND MCCONKIE, 60 EAST SOUTH TEMPLE,, SUITE 1800, SALT LAKE CITY, UT, 84111, US

(73) Assignee: PRIMAX ELECTRONICS LTD., Taipei (TW)

(21) Appl. No.: 11/470,464

(22) Filed: Sep. 6, 2006

(30) Foreign Application Priority Data
Jul. 17, 2006 (TW) 095125985

(51) Int. Cl. G06K 9/40

(52) U.S. Cl. 382/274

(57) ABSTRACT

A method for obtaining a high signal-to-noise ratio (SNR) image includes the following steps. Firstly, plural images of an object are continuously captured by an image capture device at a fixed object distance and a fixed focal position. Each of the plural images includes N pixels, where N is an integer. Then, a calculating operation is performed on the image intensities of the pixels of the same serial numbers for the plural images to obtain N calculated image intensities. Afterwards, the high SNR image is generated. The high SNR image includes N pixels having image intensities corresponding to the N calculated image intensities, respectively.

### FIELD OF THE INVENTION

The present invention relates to a method for obtaining an image, and more particularly to a method for obtaining a high SNR image.

### BACKGROUND OF THE INVENTION

Currently, image capture devices such as digital cameras and camera phones are widely used to take images. For meeting vision and practical requirements, these images should be further processed. Generally, during the process of capturing and transmitting the digital images, noise is readily generated due to some factors. For example, for most image capture devices, the brightness of the light source and the ambient temperature of the image sensor are responsible for generation of the noise. In addition, the digital images transmitted by the wireless network system are possibly distorted on account of lightning or other noise in the air.

As known, the noise may result in distorted image signal. Typically, a signal-to-noise ratio (SNR) of the image signal is used to evaluate the imaging quality. As the signal-to-noise ratio (SNR) is increased, the noise is lowered and the imaging quality is increased.

Generally, the image processing operations include an image pre-processing operation and an image post-processing operation. The digital images taken by an image capture device and having not been processed are referred as raw data. The image pre-processing operation includes the procedure of obtaining the raw data. The image post-processing operation includes for example auto focus, auto exposure or the like. After the image post-processing operation, the processed digital images have imparted thereto some specified imaging effects.

An example of the common image post-processing operation includes but is not limited to noise reduction of the raw data, white balancing, interpolation, color calibration, gamma correction, color space conversion from RGB to YCbCr, edge enhancement, saturation enhancement, false color suppression, or the like. After the image post-processing operation, YCbCr images with high quality are obtained. For static image application, these YCbCr images are successively processed by discrete cosine transform (DCT) quantization, Huffman coding and Header packaging operations to be converted into JPEG files.

According to a conventional method of reducing noise of the digital image, a low pass filter is used for filtering off the high-frequency components but retaining the low-frequency components. Please refer to FIG. 1, which is a schematic view illustrating a digital image containing noise to be eliminated according to the conventional method. As known, every digital image includes a plurality of pixels, and each pixel displays several different colors. For clarification, only five pixels A, B, C, D and E are shown in FIG. 1 to be formed as a color block. The pixels A, B, C and D are normal pixels having image intensities Ia, Ib, Ic and Id, respectively. The image intensities Ia, Ib, Ic and Id are substantial identical. The pixel E contains noise, and has an image intensity Ie. Since the pixel E contains noise, the image intensity Ie is greater than each of Ia, Ib, Ic and Id. For avoiding influence of the noise contained in the pixel E, an arithmetic mean of the image intensities Ia, Ib, Ic, Id and Ie is calculated by the low pass filter. This arithmetic mean is used as a new image intensity of the pixel E in replace of the original intensity Ie. After processed by the low pass filter, the new image intensity of the pixel E is closer to each of Ia, Ib, Ic and Id. That is, the noise contained in the pixel E is lowered. Although the low pass filter is able to reduce the noise, the low pass filter still has some drawbacks. For example, the sharpness at the image edge or the tissue boundary is also reduced. In other words, due to diffusive blur occurred in the boundary and the minute tissue, distorted image are readily generated.

In views of the above-described disadvantages resulted from the prior art, the applicant keeps on carving unflaggingly to develop a method for obtaining a high SNR image according to the present invention through wholehearted experience and research.

### SUMMARY OF THE INVENTION

It is an object of the present invention to provide a method for obtaining a high SNR image.

In accordance with an aspect of the present invention, there is provided a method for obtaining a high signal-to-noise ratio (SNR) image. Firstly, plural images of an object are continuously captured by an image capture device at a fixed object distance and a fixed focal position. Each of the plural images includes N pixels, where N is an integer. Then, a calculating operation is performed on the image intensities of the pixels of the same serial numbers for the plural images to obtain N calculated image intensities. Afterwards, the high SNR image is generated. The high SNR image includes N pixels having image intensities corresponding to the N calculated image intensities, respectively.

In an embodiment, the calculating operation is performed to obtain the arithmetic mean of the image intensities of the pixels of the same serial numbers for the plural images.

In an embodiment, the calculating operation is performed to obtain the median of the image intensities of the pixels of the same serial numbers for the plural images.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic view illustrating a digital image containing noise to be eliminated according to a conventional method;

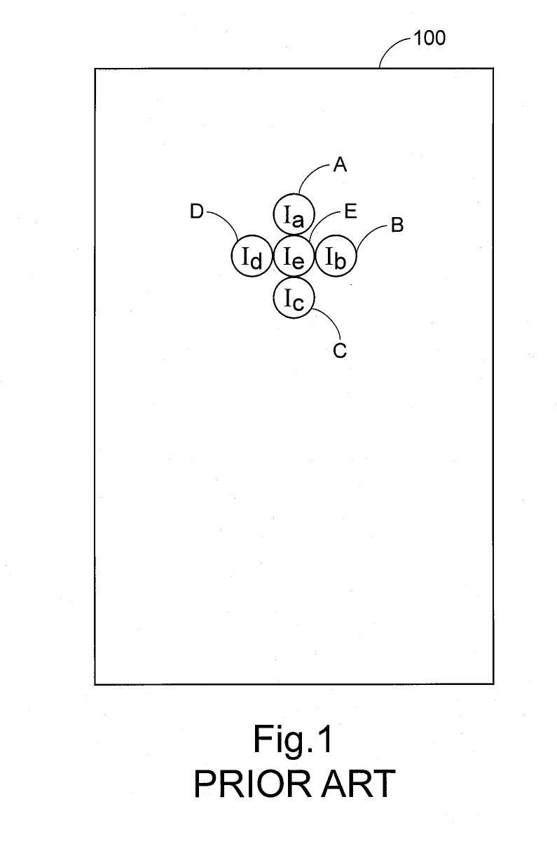

FIG. 2 is a normal distribution curve plot illustrating the relation between the image intensities versus the probability density; and

FIG. 3 is a schematic view illustrating a digital image containing noise to be eliminated according to a preferred embodiment of the present invention.

### DETAILED DESCRIPTION OF THE PREFERRED EMBODIMENT

The present invention provides a method for obtaining a high SNR image in order to eliminate noise and improve the distorted image.

In views of noise, a general noise model is denoted as I(nim,i,j)=I(im,i,j)+amplitude×N(0,1), where I(im,i,j) is a true signal, I(nim,i,j) is the sum of the true signal and the noise and the term Amplitude denotes a multiplicand. The term N(0,1) is a random variable ranged from 0 to 1 in a normal distribution mode. Since the image noise is very close to the normal distribution, the noise is assumed to obey the normal distribution when the noise model is analyzed. The normal distribution is also called a Gaussian distribution. From the noise model, it is found that the noise is randomly added to the true signal. The relation between the true signal and the noise will be illustrated with reference to a plot of the normal distribution.

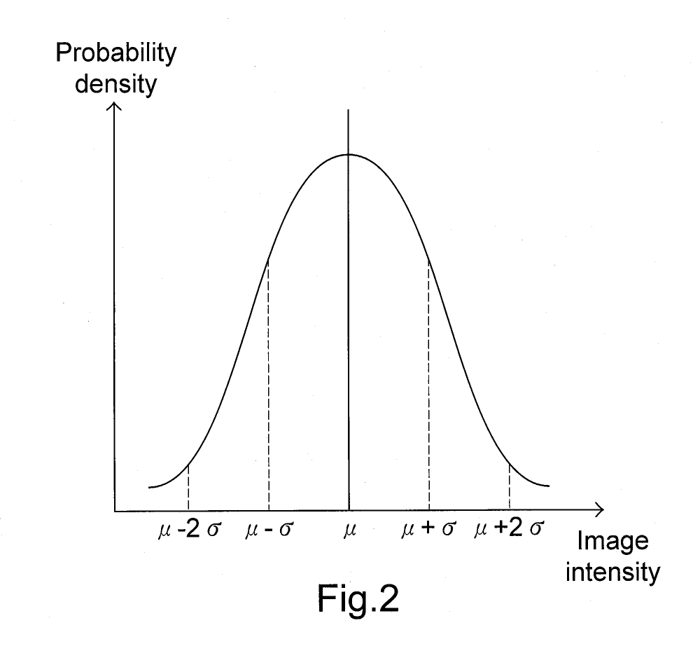

FIG. 2 is a normal distribution curve plot illustrating the relation between the image intensities versus the probability density. In FIG. 2, the horizontal axle indicates the image intensity, and the vertical axle indicates the probability density. In the horizontal axle, the term μ denotes an expected value and the term σ denotes a standard deviation. The noise image is distributed under the curve. As can be seen in FIG. 2, the image intensity of the true signal is equal to the expected value μ.

Hereinafter, an embodiment of the present invention will be illustrated as follows in more details.

First of all, plural images of an object are successively captured by an image capture device such as a digital camera at a fixed object distance and a fixed focal position. Each of the plural images has plural pixels, and each pixel has respective image intensity. Then, the image intensities of the pixels of the same serial numbers are calculated to obtain an arithmetic mean or a median of these image intensities. After this calculation, the true signal with lowered noise is exhibited.

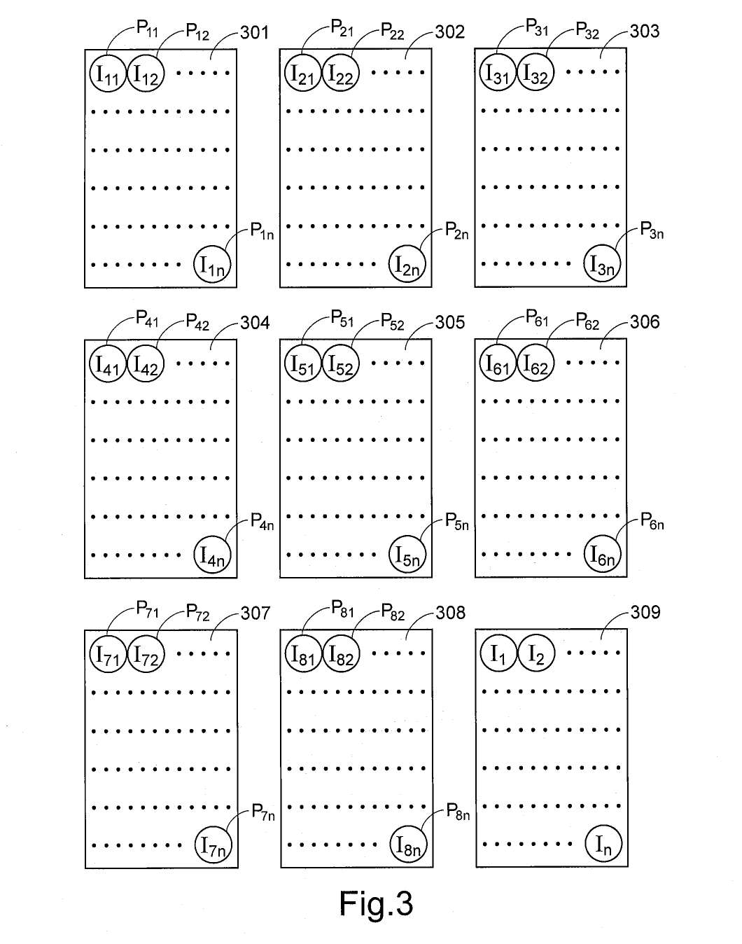

Please refer to FIG. 3, which is a schematic view illustrating a digital image containing noise to be eliminated according to a preferred embodiment of the present invention. In this embodiment, an arithmetic mean is obtained after the calculation. As shown in FIG. 3, eight images of an object, i.e. the images 301, 302, 303, 304, 305, 306, 307 and 308, are continuously captured by a digital camera at a fixed object distance and a fixed focal position. Each of these eight images has N pixels, where N is an integer. For example, the image 301 include N pixels P11, P12, . . . , and P1n. The pixels P11, P12, . . . , and P1n have image intensity I11, I12, . . . , and I1n, respectively. Likewise, the image 302 include N pixels P21, P22, . . . , and P2n. The pixels P21, P22, . . . , and P2n have image intensity I21, I22, . . . , and I2n, respectively. The rest may be deduced by analogy.

For eliminating the noise, the image intensities of the pixels of the same serial numbers for these eight images are calculated to obtain an arithmetic mean, which is new image intensity in replace of the original intensity. For example, the image intensities of the first pixels of the images 301˜308 are calculated to obtain the arithmetic mean I1 of the first pixels I11, I21, I31, I41, I51, I61, I71 and I81. Next, the image intensities of the second pixels of the images 301˜308 are calculated to obtain the arithmetic mean I2 of the first pixels I12, I22, I32, I42, I52, I62, I72 and I82. The rest may be deduced by analogy, so that the third, fourth. . . . , nth pixels of the images 301˜308 are calculated to obtain the arithmetic mean I3, I4, . . . , and In. Next, the original image intensities of the first to the Nth pixels are replaced with the calculated image intensity I1, I2, . . . , In, thereby generating a high SNR image 309. That is, the high SNR image 309 includes N pixels of the image intensity I1, I2, . . . , and In.

Please refer to the normal distribution curve plot of FIG. 2 again. Since the arithmetic mean of the image intensities is equal to the expected value μ, the arithmetic mean of the image intensity is very close to that of the true signal. Whereas, the image intensities of the pixels of the same serial numbers for these eight images can be calculated to obtain a median, which is also effective to obtain the high SNR image because the median is near the expected value μ. Depending on the differences between the image intensities of these images, the arithmetic mean or the median is selectively calculated. For example, in a case that the image intensities of the pixels of the same serial numbers are almost identical, the arithmetic mean is preferably calculated. In another case that one of the pixels of the same serial numbers has unusual image intensity, for example the maximum image intensity is very large or the minimum image intensity is very small, calculation of the median is appropriate.

As previously described, the conventional method of eliminating the noise uses a low pass filter and calculates the arithmetic mean of the image intensities of the noisy pixel and the surrounding pixels. The arithmetic mean of the image intensities is close to the image intensity of each surrounding pixel, so that the amplitude of the undulant noise is lowered. Unfortunately, since the true signal and the noise are simultaneously lowered, the obtained image is usually distorted. In contrast, according to the method of the present invention, since plural images of a same object are continuously captured, the true signal components of these captured images are identical but the noisy components are somewhat varied. By calculating the image intensities of the pixels of the same serial numbers for these captured images, an arithmetic mean or a median which is very close to the image intensity of the true signal is obtained. As a consequence, a high SNR image with lowered noise and no distortion is generated.

In the above embodiments, the procedure of continuously capturing the plural images can be programmed. After a first image of the object is shot, the program will actuate the image capture device to continuously capture the other (N−1) images. The further actions of the image capture device can be implemented by the program. Therefore, the method of the present invention is both convenient and user-friendly.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for obtaining a high signal-to-noise ratio (SNR) image, comprising steps of:
continuously capturing plural images of an object by an image capture device at a fixed object distance and a fixed focal position, each of said plural images including N pixels, where N is an integer;
performing a calculating operation on the image intensities of the pixels of the same serial numbers for said plural images are calculated to obtain N calculated image intensities; and
generating said high SNR image including N pixels having image intensities corresponding to said N calculated image intensities, respectively.

2. The method for obtaining a high SNR image according to claim 1 wherein said calculating operation is performed to obtain the arithmetic mean of the image intensities of the pixels of the same serial numbers for said plural images.

3. The method for obtaining a high SNR image according to claim 1 wherein said calculating operation is performed to obtain the median of the image intensities of the pixels of the same serial numbers for said plural images.
